(19) United States
(12) Patent Application Publication
(10) Pub. No.: US 2020/0348118 A1
(43) Pub. Date: Nov. 5, 2020

(54) Edge, runout, and true center of rotation finder

(71) Applicant: Robert S. Scher, Clifton Park, NY (US)

(72) Inventor: Robert S. Scher, Clifton Park, NY (US)

(21) Appl. No.: 16/501,578

(22) Filed: May 2, 2019

(51) Int. Cl. G01B 3/00; G01B 5/20

(52) U.S. Cl. CPC G01B 3/002; G01B 5/201

(57) ABSTRACT

A device for finding the runout of a machine spindle. The device includes a ball bearing mounted to the end of a short, precision shaft. The ball bearing includes a pattern of dots or similar markings on an upper face of an outer ring of the bearing. The device is mounted into a chuck attached to a spindle and is lowered to the level of an edge of a workpiece. A workpiece edge is moved toward the bearing of the device. A machinist zero's out a digital position readout of the machine's lead screw dial when the workpiece first contacts the bearing. The machinist determines the amount of runout of the spindle by observing the motion of the pattern on the bearing as the workpiece moves from first contact with the bearing to a point when the bearing stops moving.

### STATEMENT

There was no federally sponsored research or development used in this invention.

### BACKGROUND OF THE INVENTION

NOTE: Throughout this document the term Finder will be used as a shortened version of the more cumbersome Edge, Runout and True Center of Rotation Finder, and TCR will be used for True Center of Rotation, which is the geometric axis of the machine spindle bearings.

Typically milling or similar machines are fitted with a chuck or collet to hold the cutting tool, which may be a drill, end mill, boring head or other. Because of manufacturing tolerances and other factors, the geometric axis of the chuck may not be perfectly coincident with the TCR, but rather is offset from it. As shown in FIG. 3 the offset causes the geometric axis of the chuck, as it rotates, to move around in a small circle, centered on the TCR, whose radius is E, the Eccentricity. Such eccentric motion introduces errors in positioning the chuck and cutting tool, which directly affect the accuracy of the machined part. In addition, the machine spindle itself has runout, usually less than the chuck runout. The two together constitute the total eccentric motion, i.e. the total machine runout. It is important to know the total runout because it determines the maximum accuracy obtainable in the parts made on the machine. Further, common requirements of Finders are to find centers of holes, location of central axes between parallel features and of symmetric features on the part, and the edges of the workpiece. The Finder performs all of these functions in one simple machine/Finder configuration.

### SUMMARY OF THE INVENTION

The invention (Finder) finds edge location, TCR, runout, hole centers and centerlines of radially symmetric parts. Its simple design of only two parts leads to low manufacturing cost, ease of use, easy calibration and high accuracy. A large number of edge finders on the market are used for these purposes, but none of them has the total combination of the features found in the subject of this patent.

Finding the edges of the workpiece is most often the first step in the machining operation, since the locations of all machined features are ultimately specified in terms of distance from the edges of the workpiece. Thus, edge finders are a staple of the accessory tools used in machine shops not employing CNC machinery.

### DRAWINGS

FIGS. 1, 2, 3 and 3(a) are on Replacement Sheets, which have been altered for better clarity and conformity with standard formatting. No substantial changes in content have been made, but another Figure, (3a) has been attached as an optional replacement for FIG. 3, in the interest of easier interpretation.

FIG. 1 describes the overall configuration of the invention and the manner in which it would typically be used.

FIG. 2 is a top view of the ball bearing without its shields.

FIG. 3 describes the basic operating principle. It shows the workpiece edge at the high and low points of the chuck runout, and the corresponding positions of the Finder ball bearing.

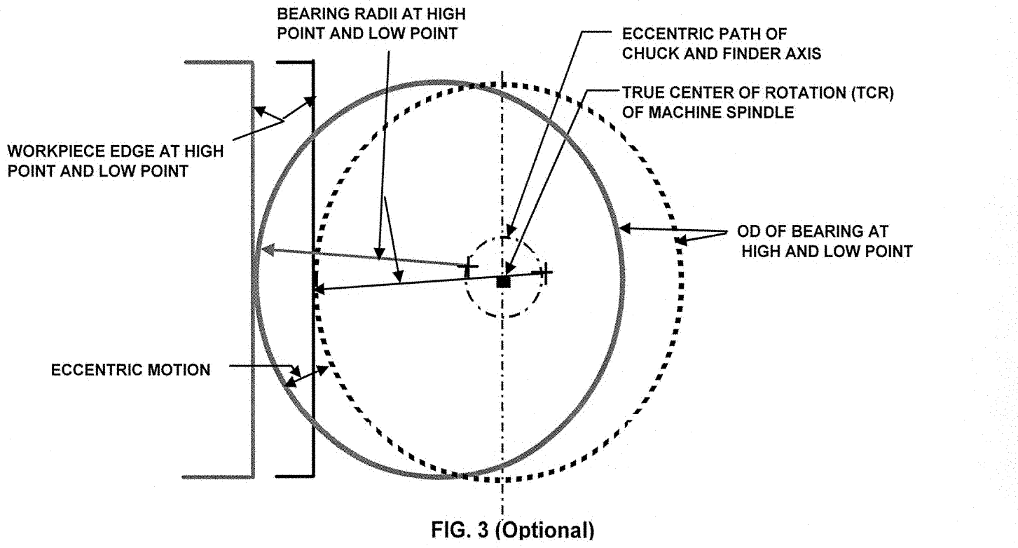

Optional FIG. 3(a) has the same content as FIG. 3, but legends have been used instead of identifying numbers, for better clarity.

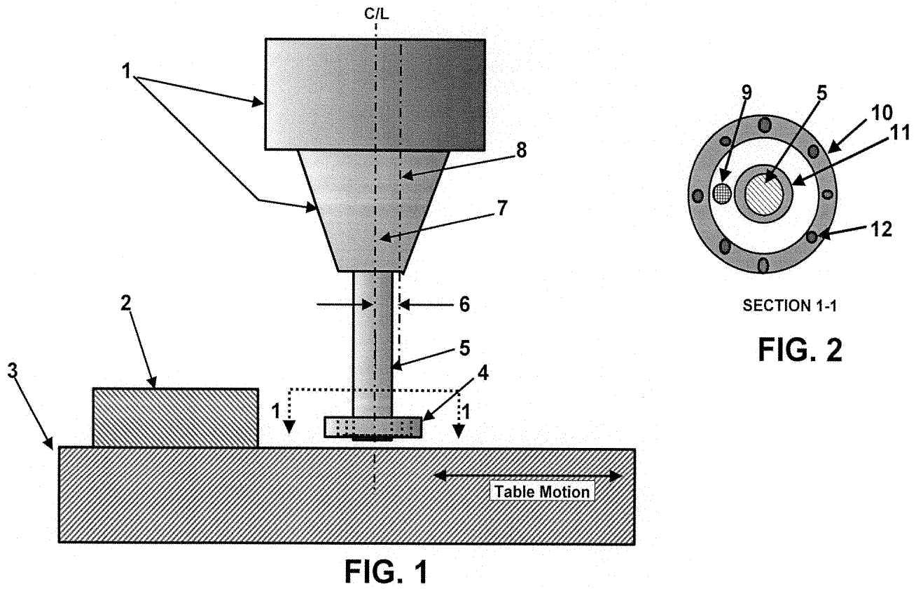

### LIST OF ITEMS SHOWN IN FIGS. 1 and 2 and 3

1 Chuck

2 Workplace

3 Machine table

4 Finder ball bearing

5 Finder shaft

6 Displacement of the chuck axis relative to the TCR

7 Geometric axis of chuck

8 Axis of rotation of machine spindle

9 Typical bearing ball

10 Ball bearing outer ring

11 Ball bearing inner ring

12 Markings on face of ball bearing outer ring

13 Workplace edge at high and low points

14 Bearing radius at high and low points

15 Eccentric motion of shaft and ball bearing

16 Eccentric path of chuck and Finder axis

17 Machine True Center of Rotation (TCR)

18 O D of bearing at high and low points

List of Abbreviations
TCR True center of rotation (the machine spindle bearings axis)
E Eccentricity of the chuck axis and Finder relative to the TCR
RO Total (peak to peak) eccentric motion of the chuck=2E
ROFinder Runout as measured by the Finder=(2E+P)
ROwith tool=(ROfinder−P)=2E
Ewith tool=(ROwith tool−P)/2
Rb Radius of the ball bearing as specified by the manufacturer
P Bearing play as specified by the manufacturer
S Distance measured in the procedure pertaining to Eq. 3
DRO Digital Readout of X and Y table positions
W Width of gauge block as specified by the manufacturer
Wm Width of gauge block as measured with Finder

Specification

Note: For ease of reading, all dimensions smaller than 0.0001 will be presented in the format 0.000 000.

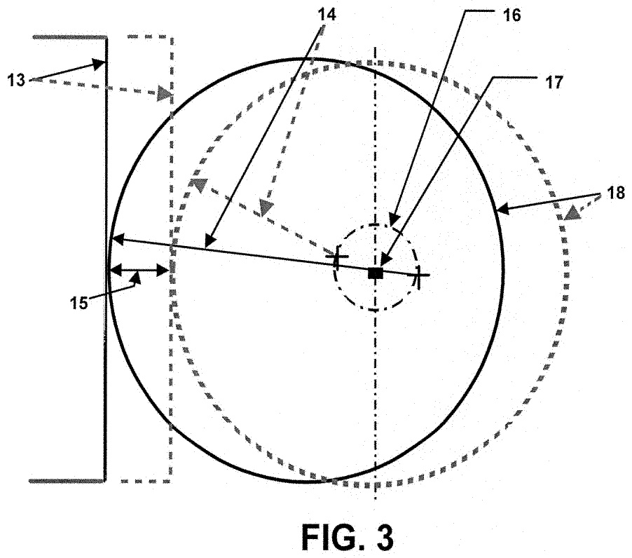

The Finder consists solely of an accurate ball bearing (4) mounted to the end of a short precision shaft (5), as shown in FIG. 1. In FIG. 2 it is seen that a pattern of dots or similar markings is placed on the upper face of the bearing's outer ring (10). These marks may be applied directly, by means of an overlay or any other means, and need not necessarily be located on the bearing face. Also, the markings are preferably placed at approximately equal intervals. The Finder is mounted into a chuck which is lowered to the level of the workpiece edge (2). The spindle (8) is set to rotate at any convenient speed. The ball bearing's outer ring rotates at the same speed as the shaft and chuck, so the markings on the outer ring will be traveling rapidly, appearing as a steady blur to the operator. Because of the offset (6), the chuck and Finder are moving in a small circle about the TCR as they rotate about their own axes, as shown schematically in FIG. 3. The radius of the circle is the offset (eccentricity). Thus as the chuck rotates, the ball bearing is moving toward and away from the workpiece. This motion is known in the trade as runout, which is characterized as having a high point (closest to the workpiece) and a low point (farthest from the workpiece) as shown in FIG. 3. When the workpiece is moved toward the Finder, and when it just barely touches the bearing outer ring at the high point, the outer ring stops for the instant it is in contact with the workpiece, and the dot pattern begins to “stutter”, disturbing the regular rotation of the pattern, which is readily observed by the machinist. The table position is “zero'd out” at this point, either on a Digital Position Readout, or by resetting the machine's lead screw dial to zero. As the workpiece is moved closer to the low point, it first takes up the bearing play and then becomes more and more in contact with the bearing outer ring, and the motion of the dot pattern becomes more and more irregular. This continues until the workpiece edge reaches the low point of the runout, at which point it is in contact with the outer ring for a full revolution, and the ring stops rotating altogether. The precise moment of complete contact is very easy to discern visually, because the markings on the outer ring come to a complete stop. When this happens the position readout corresponds to the distance from the high point to the low point, including the bearing play, which is the runout, RO.

With this method, runout (RO) can be determined within ˜ 0.0004″ with relative ease. An important feature of this method is that the operator easily observes the pattern changes while in a comfortable standing position.

The Effect of Bearing Play

The bearing Play is the total space between the bearing balls and it's inner and outer races, as shown in FIG. 1. When the workpiece edge is just about to contact the Finder, the ball bearing it is at the high point. The balls are uniformly pressed against the outer race due to centrifugal force, and the outer ring rotates with the spindle at its nominal undisturbed condition. At that point the distance from the TCR to the workpiece edge is Rb+E, where Rb is the bearing radius and E is the eccentricity. However as the workpiece edge continues to move, the bearing play P (typically ˜0.000 350 for an ABEC 5 or 7 bearing) is quickly taken up, and the outer race and balls are pushed against the inner race and shaft. At this point P=0 and the effective radius of the bearing is Rb−P. When the workpiece edge continues to the low point its distance from the TCR is Rb−P−E.

Thus: Total workpiece edge motion=ROfinder=(Rb+E)−(Rb−P−E)=2E+P, and E=(ROFinder−P)/2
(note that when a tool is in the chuck, there is no play)

So P=0, and E=ROfinder/2. Eq(1)

where
ROfinder is the total travel as measured by the Finder as it goes from the high point, through P, and on to the low point.
RO is the actual runout when P=0, i.e. the runout with a tool in the chuck; E=ROfinder/2
Rb is the radius of the ball bearing
E is the eccentricity
P is the bearing play, specified by the bearing manufacturer (typically 0.000 350+/−0.000 150 for ABEC 5 and 7 bearings)

Since the values of all the above variables are known either from manufacturer's specification or actual measurement, the value of E is readily determined.

Placing the Chuck and Tool Directly Over the Edge of the Workpiece

If the workpiece edge is at the high point, it is Rb+E away from the TCR. Therefore raise the machine head, place the cutting tool in the chuck and move the workpiece the distance Rb+E toward the chuck, and the workpiece edge will be exactly under the TCR. If the workpiece edge is at the low point, it is Rb−E−P from the TCR; therefore place the cutting tool in the chuck (then P=0) and move the workpiece Rb−E away from the chuck, and the workpiece edge will be exactly under the TCR. Note that placing the workpiece edge under the TCR, automatically locates the TCR as well.

Thus, in addition to finding edges, the Finder finds both the eccentricity (E), the runout (2E) and locates the TCR of the machine. It provides the information necessary to place the workpiece edge under the TCR to high accuracy, and with relative ease. E and runout (2E) are among the fundamental measures of the machine's accuracy. It is the offset of the chuck axis of rotation from the machine TCR and it applies to the particular machine/chuck combination. It is a constant that stays with the machine and the chuck. This means that once E is determined, it does not have to be remeasured for every future operation of the machine with the same chuck, but rather on a quality check schedule. Most of the time the Finder is used simply to locate the workpiece edge. If other chucks or collets are used, they too can be calibrated and “cataloged”, and the calibration applied according to which particular chuck or collet is in use.

[One example of the utility of the Finder: A typical requirement of the machining process is to place a hole in a cylindrical part (a shaft), perpendicular to the shaft, and through its axis i.e. a cross-drilled hole. This is often done by clamping the shaft horizontally in the machine vice, and drilling through it at the midpoint between the two vice faces. Finding the midpoint is typically a clumsy task, but the Finder makes short work of it. Simply place the Finder in the chuck, lower it between the vice faces, move the machine table toward the Finder (in the Y direction) until one of the faces reaches the high or low point. Zero out the readout, and move the table to the corresponding high or low point at the other face. Dividing the readout position by 2 gives the precise location of the shaft axis with high accuracy. This same procedure can be used to quickly find the centers of holes or the center of a symmetrical workpiece such as a solid disk or regular trapezoid.]

Method for Verifying Accuracy

The Finder is mounted into the chuck of the machine, and a highly accurate gauge block is mounted in the machine's work vice, square to the machine table. The table is moved right to left until the gauge block contacts the bearing outer ring, passes through the high point and continues until it reaches the low point. where the DRO is set to zero. In this position the leftmost edge of the gauge block is at position 0.000 000. Then the table is backed away (left to right) from the Finder, the spindle head is raised, the table is moved to the other side of the Finder, and lowered into position. Then the process described above is repeated, but with the gauge block approaching the Finder from left to right. Note that in this position, the leftmost edge of the gauge block has traveled Distance D and

D=2 (Rb−P−E)+Wm Wm is the measured gauge block width and Wm=D−2 (Rb−P−E) (Eq. 2)

The table's travel, as measured by the lead screw or digital readout is recorded. Rb and P are known from the manufacture's specification, and E is found from Eq. (1). Then Wm is compared with the manufacturer's stated width, (W), any difference between the two represents the error of the Finder.

Error Budget

1-5. (canceled)

6. A finder device comprising a shaft with a ball bearing mounted at its end, with markings placed at approximately equal spacing on the bearing outer race, preferably on its upper face, in any suitable manner, and which in use is installed in the chuck or collet of a milling or other machine tool.

7. A finder as set forth in claim 6 whose operation comprises direct observation of the motion of the rotating markings as a workpiece is moved toward the Finder and comes into first contact with the bearing, and proceeds from first contact to final position, where both events are denoted by obvious changes in the pattern motion, and the workpiece motion is displayed on a digital position readout.

8. A finder as set forth in claim 6 that in the process of moving from first contact to final position, accurately locates the workpiece edge and other geometry such as the centers of holes and other symmetric features, and whose total observed motion allows the values of basic machine parameters, including Eccentricity, total spindle Runout and True Center of Rotation to be readily calculated using simple arithmetic.

9. A finder as set forth in claim 6 whose accuracy and repeatability can rapidly and easily be verified using only a gauge block or similar length standard of convenient length, mounted into the work vice on the machine tool table, and whose rightmost and leftmost face locations are determined by the Finder as described by claims 1 through 3, and the difference in the locations is compared with the specified width of the gauge block to establish accuracy.

10. A finder as set forth in claim 6 whose functioning is observed when the operator is in a comfortable standing position.

11. A finder as set forth in claim 7 whose functioning is observed when the operator is in a comfortable standing position.

12. A finder as set forth in claim 8 whose functioning is observed when the operator is in a comfortable standing position.

13. A finder as set forth in claim 9 whose functioning is observed when the operator is in a comfortable standing position.
